(19) United States
(12) Patent Application Publication
(10) Pub. No.: US 2020/0410369 A1
(43) Pub. Date: Dec. 31, 2020

(54) DATA-DRIVEN CROSS FEATURE GENERATION

(71) Applicant: Microsoft Technology Licensing, LLC, Redmond, WA (US)

(72) Inventors: Qing Duan, Santa Clara, CA (US); Jianqiang Shen, San Mateo, CA (US)

(21) Appl. No.: 16/457,773

(22) Filed: Jun. 28, 2019

(51) Int. Cl. G06N 5/04; G06N 20/00

(52) U.S. Cl. CPC G06N 5/04; G06N 20/00

(57) ABSTRACT

Techniques for generating cross features using a data driven approach are provided. Multiple possible splits of a numerical feature are identified. For each split, the numerical feature is transformed into a second feature based on the split, a cross feature is generated based on the second feature and a third (e.g., categorial) feature that is different than the first feature and the second feature, a predictive power of the cross feature is estimated, and the predictive power is added to a set of estimated predictive powers. After each split is considered, a cross feature that is associated with the highest estimated predictive power in the set of estimated predictive powers is selected. That first cross feature corresponds to a particular split from the multiple possible splits. The numerical feature is split based on the particular split to generate a bucketized version of the numerical feature.

### TECHNICAL FIELD

The present disclosure relates to machine learning and, more particularly to, generating cross features using a data driven approach.

### BACKGROUND

Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with users. The statistical model is trained based on multiple attributes. In machine learning parlance, such attributes are referred to as “features.” To generate and train a statistical prediction model, a set of features is specified and a set of training data is identified.

Examples of predictions that a machine-learned model might make include predicting whether a user will select a content item that is presented to the user, predicting an amount of time that a user might spend viewing a content item, predicting any other type of action (online or otherwise) that a user might perform, or predicting the occurrence of any other type of event. Many machine-learned models involve both numerical features and categorical features. Examples of numerical features include time, age, and salary. Examples of categorical features include spatial features, such as country, state, region, and neighborhood.

Temporal features are naturally numeric, can be ordered, and can be in different granularity, such as minute, hour, day, week. Temporal features are usually transformed into categorical features by discretization. On the other hand, spatial features are naturally categorical. Present approaches for designing and training machine-learned models involve pre-processing and transformed numerical (e.g., time-domain) features and categorical (e.g., space-domain) features independently. However, independently prepared features are not always predictive. Instead, a cross of numerical and categorical features can generate more predictive features.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a diagram that depicts an overview of a process for generating a cross feature based on a numerical feature, in an embodiment;

FIGS. 2A-2B are flow diagrams that depict an example process for generating a cross categorical feature from a numerical feature, in an embodiment;

FIGS. 3A-3C are diagrams that depict an example numerical feature that is being bucketized at different stages of the example process of FIGS. 2A-2B, in an embodiment;

FIG. 4 is a chart that illustrates a time complexity of bucketizing a numerical feature using two different approaches as the number of buckets increases;

FIGS. 5A-5B are flow diagrams that depict another example process for generating a cross categorical feature from a numerical feature, in an embodiment;

FIG. 6 is a chart that illustrates how estimated predictive power converges and how the number of buckets can be determined using a given threshold value using the other example process, in an embodiment;

FIG. 7 is a diagram that depicts an overview of a process for generating a cross feature based on two numerical features, in an embodiment;

FIG. 8 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for crossing a numerical feature with a categorical or numerical feature to generate a cross feature using a data-driven approach are provided. The data-driven approach maximizes the predictive power of the cross feature. In a related approach, the generation of the cross feature is performed in a scalable way so that many numerical features may be considered as candidates for different cross features.

In order to generate a cross feature from two other features, at least one of which is a numerical feature, the numeric feature is bucketized into n buckets and the other feature (such as a categorical feature) is associated with m categories. The bucketized numerical feature is crossed with the other feature to generate a new crossed feature comprising n×m dimensions. Different ways of bucketizing a numerical feature are considered when crossing the bucketized numerical feature with another feature. Each candidate cross feature is analyzed to determine whether incorporating that cross feature into a machine-learned model is likely to yield positive results.

Embodiments improve computer technology, specifically computer technology related to automatically generating a cross feature from at least one numerical feature for a machine-learned model where the cross feature has high predictive power. Prior approaches to generating a cross feature relied on faulty human intuition regarding how to divide a numerical feature into different ranges. Such human intuition lacks the precise knowledge of the underlying data in addition to how the data changes over time. Embodiments result in machine-learned models with more predictive power than machine-learned models that are based on cross features determined through a naïve manual approach.

### Numerical V. Categorical Features

A numerical feature is a feature whose values pertain to a range of numbers, such as real-valued numbers. Examples of numerical features includes time-based features, such as an event time (e.g., time of day) or recency (e.g., the lapse of a certain period of time), such as in milliseconds, seconds, minutes, or hours. Other examples of numerical features include age (which has a minimum value of 0), salary (which also has a minimum value of 0), account balance (which may be a negative number), average community rating (which may have range of 0 to 5), temperature (e.g., in Fahrenheit), a number of online connections in an online connections network (e.g., an online social network), a score generated by a machine-learned model (e.g., a score between 0 and 1 that represents a probability), a number of messages sent, and number of products delivered (which also has a minimum value of 0). For numerical features, categories are not necessarily inherent in their respective values.

A categorical feature is a feature whose individual values are naturally mapped to a particular category. Examples of categorical features include spatial features, such as country, state, region, or neighborhood. Other examples of categorical features include job title, job industry, job function, seniority, employer, skill, academic institution attended, academic degree earned, and a specific rating (e.g., low, medium, high).

### Process Overview

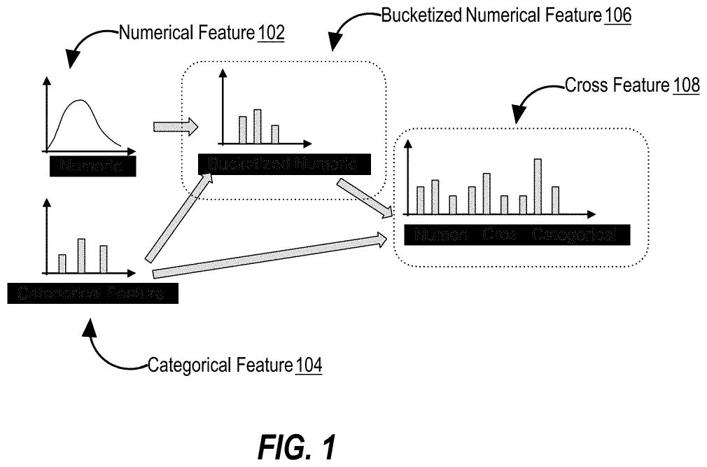

FIG. 1 is a diagram that depicts an overview of a process for generating a cross feature based on a numerical feature, in an embodiment. A cross feature is based on two other (“base”) features. At least one of the base features is numerical feature 102. The other feature in this example is categorical feature 104. Both numerical feature 102 and categorical feature 104 are used as input to generate a bucketized version of numerical feature 102, which bucketized version is referred to as bucketized numerical feature 106. Bucketized numerical feature 106 and categorical feature 104 are used as input to generate cross feature 108. Without embodiments described herein, bucketized numerical feature 106 would not have been bucketized based on categorical feature 104. Thus, cross feature 108 would likely not be optimal in terms of predictive power.

### Feature Predictive Power

Different features have different predictive powers. For example, in the context of predicting whether a user will select a certain type of content item, a job industry may not have any predictive power, but a time of day may have predictive power. For example, people tend to select the certain of content item in the evening hours, but not in the morning hours. Predictive power may be reflected in a coefficient that is “learned” using one or more machine learning techniques, such as linear regression, logistic regression, neural networks, gradient boosting decision trees, support vector machines, and naïve Bayes. For example, a coefficient near 0 has less predictive power than a coefficient whose absolute value is appreciably larger than 0.

However, training a model can take a significant amount of time. Therefore, in an embodiment, predictive (or discrimination) power of a feature is estimated using one or more predictive/discrimination power estimation techniques. Such techniques include information gain, entropy, frequency, and mutual information.

### Information Gain

Information gain is based on entropy values. An entropy value for a multi-class label is denoted as Y and Y has m possible values from YValue₁ to YValueₘ. The entropy of label Y is calculated as follows:

Entropy(Y)=Σⱼ₌₁(pⱼ log₂pⱼ)

where j is from 1 to m, and pᵢ=Prob(Y=YValueⱼ). Label Y may be a binary label, such as 0 for no user click and 1 for a user click. Alternatively, label Y may be a multi-class label, such as 0 for not viewing a video, 1 for viewing a video for less than ten seconds, and 2 for viewing a video for greater than ten seconds. If the possible values of Y include a range of real values (such as time spent viewing a content item), then such real values may be mapped to buckets or categories, each category corresponding to a different sub-range of values, such as 0-2 seconds, 2-5 seconds, 5-11 seconds, and so forth.

The categorical feature X has n possible values from XValue₁ to XValueₙ. The entropy of label Y based on feature value X is defined as follows:

Entropy(Y|X)=Σᵢ₌₁{(Prob(X=XValueᵢ)*Entropy(Y|X=XValueᵢ)}

The information gain of categorical feature X for label Y is defined as follows:

InformationGain(Y|X)=Entropy(Y)−Entropy(Y|X)

In an embodiment, categorical feature X is a cross feature that is based on two features, at least one of which is a numeric feature.

### Mutual Information

In probability theory and information theory, the mutual information (MI) of two random variables is a measure of the mutual dependence between the two variables. More specifically, MI quantifies the “amount of information” obtained about one random variable through observing the other random variable. The concept of mutual information is related to that of entropy of a random variable, a fundamental notion in information theory that quantifies the expected “amount of information” held in a random variable.

Not limited to real-valued random variables and linear dependence like the correlation coefficient, MI is more general and determines how similar the joint distribution of the pair is to the product of the marginal distributions of X and MI is the expected value of the pointwise mutual information (PM).

### Bucketizing a Numeric Feature

In an embodiment, a numerical feature X is divided or “bucketized” into a n-dimensional categorical feature by defining an array of boundaries of length n+1. Bucketizing may be viewed as splitting the range of possible numerical values of feature X into different buckets so that each new category corresponds to one bucket defined by that bucket's boundaries. Thus, the i^{th} bucket corresponds to X∈(boundary₁,boundaryᵢ₊₁]

The following table illustrates, in mathematical terms, different values of numerical feature X and their corresponding buckets or categories:

TABLE A

| X | X [symbol] |
|---|---|
| x₁ | bucket₁ represented by (boundary₁, boundary₂], |
| | such that x₁ > boundary₁ & x₁ <= boundary₂ |
| . . . | . . . |
| xᵢ | bucketₙ represented by (boundaryₙ, boundaryₙ₊₁], |
| | such that xᵢ > boundaryₙ & xᵢ <= boundaryₙ₊₁ |

[symbol]

indicates data missing or illegible when filed

The size of each bucket (e.g., the difference between the boundaries of the bucket) is not required to be uniform among all buckets of a numerical feature. Thus, in an embodiment, the size of each bucket is not uniform from bucket to bucket. For example, an age feature may be divided into five buckets where the age range of each bucket is different from the age range of each other bucket.

### Crossing Two Categorical Features

A new categorical feature is generated by crossing two categorical features. One categorical feature is denoted as which has m possible values (i.e., X₁ᵢ where i∈1 to m) and another categorical feature is denoted as which has n possible values (i.e., X₂ᵢ where i∈1 to n). A cross feature that is based on the two categorical features is denoted as which will have m×n possible values (i.e., X_{1×2ij} where i∈1 to m, j∈1 to n). The following table illustrates, in mathematical terms, different values of the categorical features and a corresponding cross feature value:

TABLE B

| | X [symbol] | . . . | X [symbol] |
|---|---|---|---|
| X₂₁ | X₁ₓ₂₁₁ | . . . | X₁ₓ₂ᵢ₁ |
| . . . | . . . | . . . | . . . |
| X [symbol] | X₁ₓ₂₁ₙ | . . . | X [symbol] |

[symbol]

indicates data missing or illegible when filed

### Recursive Hueristic Algorithm

In an embodiment, a cross categorical feature is generated by first bucketizing a numerical feature into categories and then crossing the bucketized feature with another categorical feature. The numerical feature is denoted X, the bucketized version of that feature which has n buckets or categories is denoted X_{numerical_n}, the other categorical feature which has m categories is denoted X_{categorical}, the new crossed feature is denoted X_{categoricalXumerical_n}. The m possible values of X_{categorical} are denoted X_{c1} to X_{cm}. The n possible values of X_{numerical_n} are denoted Xₙ₁ to Xₙₙ.

A goal of generating a cross categorical feature based on a numerical feature is trying to find an optimal (or near optimal) n sets of bucketing boundaries (one set for each bucket) for the numerical feature such that the final crossed feature denoted as X_{categoricalXumerical_n} has the largest (or one of the largest) information gain among all possible n-bucketing boundaries for the numerical feature.

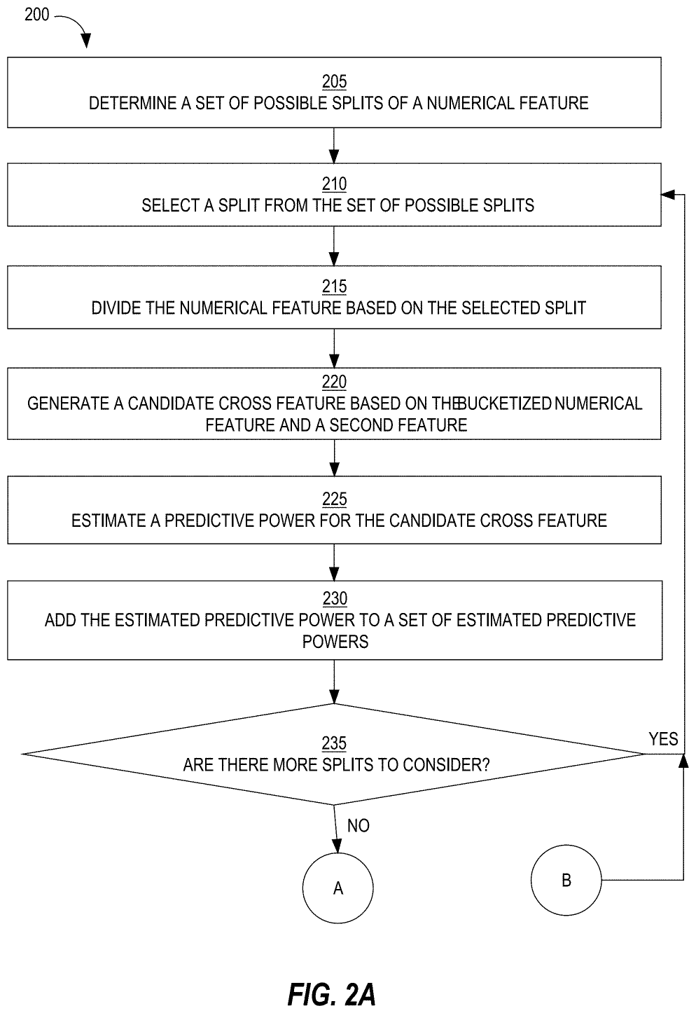

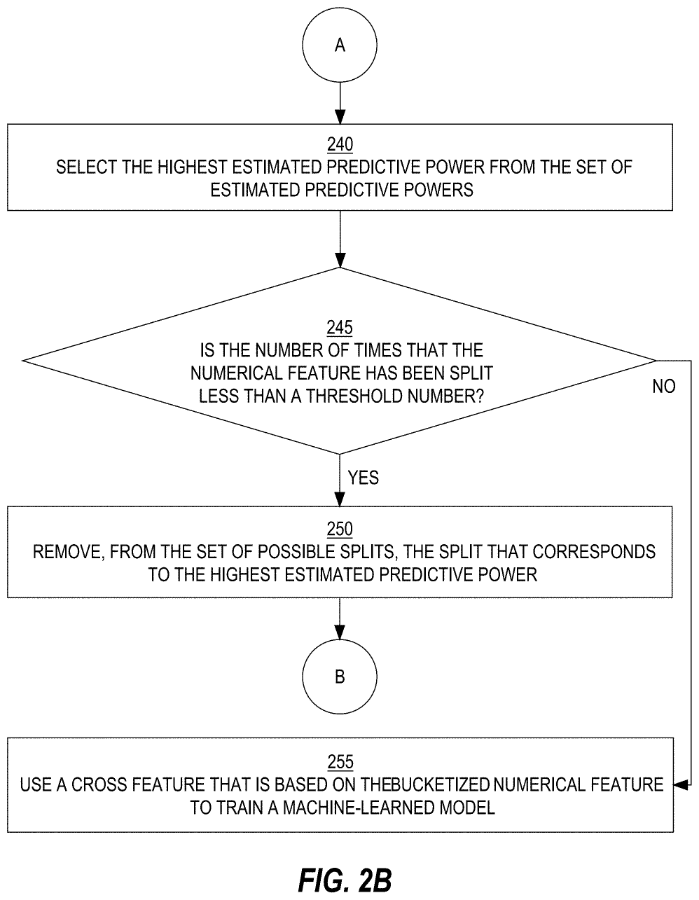

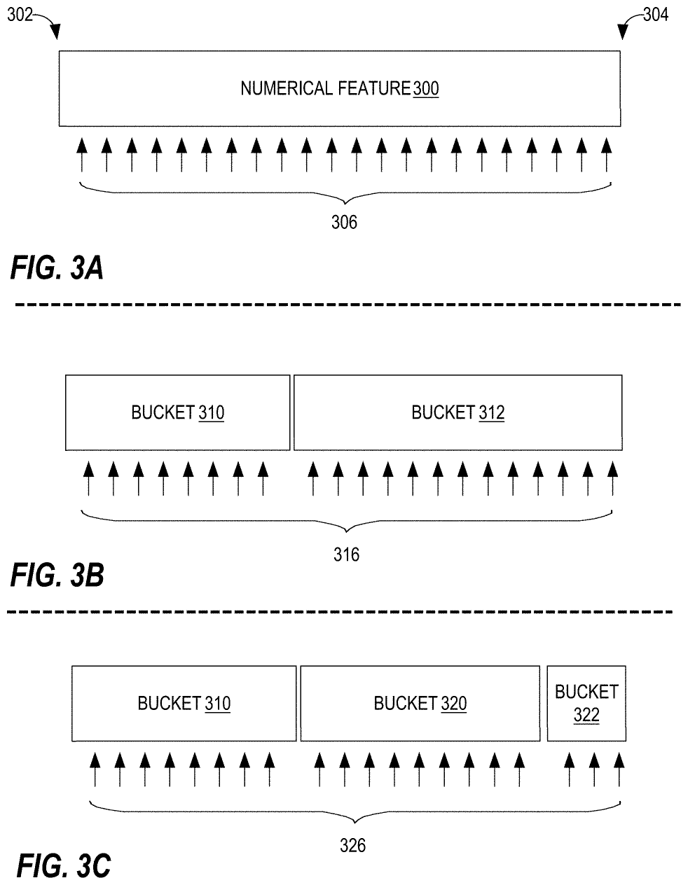

FIGS. 2A-2B are flow diagrams that depict an example process 200 for generating a cross categorical feature from a numerical feature, in an embodiment. In the description of process 200, FIGS. 3A-3C will be referenced. FIGS. 3A-3C are diagrams that depict an example numerical feature 300 that is being bucketized at different stages of process 200, in an embodiment. In process 200, the number of buckets into which the numerical feature will be split is predetermined. In another process (described in more detail below), the number of buckets is not pre-defined. Instead, a data-driven approach to determining the number of buckets is followed.

At block 205, a set of possible splits of a numerical feature is determined. Block 205 may involve identifying the finest granularity in which the numerical feature may be split. For example, if the numerical feature is a recency of a particular event, such as the length of time from the current time to the time of the particular event. The finest granularity may be hours minutes, seconds, or milliseconds, depending on the problem domain. For example, the event may be the last time a user selected a particular type of content item. Due to the nature of user selection, the finest granularity that makes sense for tracking may be minutes, not milliseconds or even seconds.

The set of possible splits of the numerical feature is based on a minimum value of the numerical feature, a maximum value of the numerical feature, and a minimum resolution. For example, an age feature may have a minimum value of 13, a maximum age of 120, and minimum resolution of one year. As another example, a recency time feature may have a minimum value of 0, a maximum value of 14 days, and minimum resolution of one minute. As another example, a time of day feature may have a minimum value of 0:0:0 (indicating midnight), a maximum value of 23:59:59 (indicating right before midnight), and minimum resolution of one second (or one minute).

In FIG. 3A, numerical feature 300 is initially viewed as a single bucket. Numerical feature 300 represents a range of values where the left edge 302 represents the minimum value of numerical feature 300 and the right edge 304 represents the maximum value of numerical feature 300. In the example where recency is the numerical feature, the minimum value may be 0 or zero seconds from the current time and the maximum value may be fourteen days. In the example where age is the numerical feature, the minimum value may be 0 and the maximum value may be one hundred years.

At block 210, one split in the set of possible splits is selected. Block 210 may involve selecting the split based on a particular order. For example, in the context of recency and the finest granularity is minutes, the first split that is selected in the first instance of block 210 is a split at the first minute, which would divide the numerical feature into two buckets, one defined by the time from the current time to the first minute and the other defined by the time range after the first minute, i.e., from the end of the first minute to, for example, fourteen days from the present. Continuing with this example the second slit that is selected in the second instance of block 210 is a split at the two minute mark, which would divide the numerical feature into two buckets, one defined by the time from the current time to the second minute and the other defined by the time range after the second minute, i.e., from the end of the second minute to, for example, fourteen days from the present.

Also, the split that is selected in block 210 has not been considered previously for this particular numerical feature that has the current bucket size. Initially, the bucket size of the numerical feature is one and the first iteration of blocks 240-245 will result in the numerical feature having two buckets. After the second iteration of blocks 240-245, the numerical feature will have three buckets, and so forth.

Possible splits 206 represent the all possible splits at the beginning of process 200. Each split in possible splits 206 is considered after block 240 is reached.

At block 215, the numerical feature is divided or bucketized based on the split selected in block 210. For example, only one of the buckets of the numerical feature is being split by the selected split. However, at the beginning of the first iteration of block 215, the numerical feature is considered to comprise only a single bucket, whose boundaries are the minimum value of the numerical feature and the maximum value of the numerical feature. At the beginning of the second iteration of block 215, the numerical feature has already been split once and, thus, comprises two buckets. At the beginning of the third iteration of block 215, the numerical feature has already been split twice and, thus, comprises three buckets. And so forth.

The bucket that is being divided based on the selected split is defined by two boundaries. This bucket is referred to as the “splitting bucket” and the buckets that result from this split are referred to as the “resulting buckets.” A lower boundary of the first resulting bucket is the same as the lower boundary of the splitting bucket, while the high boundary of the second resulting bucket is the same as the higher boundary of the splitting bucket. A higher boundary of the first resulting bucket is the value of the split, while the lower boundary of the second resulting bucket is also the value of the split. For example, a splitting bucket has a time range of 0 seconds to 30 seconds and the minimum resolution is one second. A candidate split is at 10 seconds. Thus, the first resulting bucket has boundaries defined by 0 seconds to 10 seconds (thus, a 10 second range) and the second resulting bucket has boundaries defined by 10 seconds to 30 seconds (thus, a 20 second range).

At block 220, a candidate cross feature is generated based on the bucketized numerical feature and a second feature, such as a categorical feature. For example, if there are two buckets or categories of the bucketized numerical feature and the categorical feature has three categories, then data of each training instance is analyzed to determine to which of the six categories of the candidate cross feature the training instance would be assigned. For example, two values of a training instance are identified: a first value pertaining to the numerical feature and a second value pertaining to the categorical feature. Based on (1) the first value, (2) the new boundaries of the numerical feature determined by the splits thus far, and (3) the second value, one of the six cross feature categories is identified and a count associated with that category is incremented.

At block 225, a predictive power is estimated for the candidate cross feature. For example, an information gain is calculated for the candidate cross feature.

At block 230, the estimated predictive power is added to a set of estimated predictive powers. This set is initially empty at the beginning of process 200. The number of estimated predictive power values equals the number of possible splits that have been selected thus far given the current number of buckets being considered for the numerical feature.

At block 235, it is determined whether there are any more splits to consider. In other words, it is determined whether there is at least one split in the set of possible splits that has not yet been used to split the numerical feature. If so, the process 200 returns to block 210 (where a different split is selected); otherwise, process 200 proceeds to block 240.

At block 240, the highest estimated predictive power is selected from the set of estimated predictive powers and the split corresponding to that selection is identified. For examples, it is determined that splitting a recency feature between the first three minutes and the remaining possible time range (e.g., third minute to 14 days) results in the highest estimated predictive power. Block 240 also involves clearing or emptying the set of estimate predictive powers.

At block 245, it is determined whether the number of times that the numerical feature has been split is less than a threshold number. Block 245 may involve incrementing a count after block 240 and comparing the value of the count to the threshold number (e.g., N). The threshold number may be pre-defined. If the numerical feature has been split less than N times (thus, creating less than N+1) buckets or categories, then process 200 proceeds to block 250; otherwise, process 200 proceeds to block 255.

At block 250, the set of possible splits is updated to remove the split corresponding to the highest estimated predictive power selected in block 240. Thus, the set of possible splits has one less item after block 250. A difference between possible splits 306 in FIG. 3A and possible splits 316 in FIG. 3B indicates that one of the splits from possible splits 306 is no longer in possible splits 316. Thus, the numerical feature has been split once to generate two buckets: bucket 310 and bucket 312. Buckets 310 and 312 collectively represent a bucketized version of numerical feature 300. The boundaries of bucket 310 is defined by (1) the minimum value of numerical feature 300 and (2) the numerical feature value defined by the split corresponding to the highest estimated predictive power. The boundaries of bucket 312 is defined by (1) the numerical feature value defined by the split corresponding to the highest estimated predictive power and (2) the maximum value of numerical feature 300.

After the numerical feature is split twice, the numerical feature will have three buckets or categories. FIG. 3C illustrates an example bucketization of numerical feature 300 after two splits. A difference between possible splits 316 in FIG. 3B and possible splits 326 in FIG. 3C indicates that one of the splits from possible splits 316 is no longer in possible splits 326. Thus, the numerical feature has been split twice to generate two buckets from bucket 312: bucket 320 and bucket 322. Buckets 320 and 322 collectively represent another bucketized version of numerical feature 300. The boundaries of bucket 320 is defined by (1) the minimum value of bucket 312 and (2) the numerical feature value defined by the split corresponding to the highest estimated predictive power selected in the most recent iteration of block 240. The boundaries of bucket 322 is defined by (1) the numerical feature value defined by the split corresponding to the highest estimated predictive power selected in the most recent iteration of block 240 and (2) the maximum value of bucket 312, which is the maximum value of numerical feature 300.

Process 200 then proceeds to block 210 where a split is selected but is different than any split that was removed in any iteration of block 250. However, the split that is selected in the next iteration of block 210 may have been considered in a previous iteration of blocks 210-230 when there was one less bucket of the numerical feature.

At block 255, a cross feature that is based on the bucketized/categorized numerical feature and the second (e.g., categorical) feature is used to train a machine-learned model. Process 200 effectively ends for this cross feature.

After process 200, the bucketization of the numerical feature may result in buckets or categories that are not intuitive. For example, prior to embodiments, an age feature may have been manually divided into eight buckets: one for ages 10-20, one for ages 20-30, and so forth, and one for ages 80+. However, after process 200, the age feature may be bucketized automatically into twelve buckets as follows: ages 10-12, ages 12-15, ages 15-21, ages 21-28, ages 28-36, ages 36-41, ages 41-51, ages 51-57, ages 57-63, ages 63-65, ages 65-74, and ages 74+. Though these age ranges are not immediately intuitive, they result in the highest predictive power when crossed with a categorical feature.

As another example, prior to embodiments, a recency feature may have been manually divided into the following buckets: minutes 0-30 minutes, minutes 30-60, minutes 60-90 minutes, minutes 90-120, hours 2-3, hours 3-6, hours 6-12, hours 12-24, days 1-2, days 2-7, and days 7-14. However, after process 200, the recency feature may be bucketized automatically into the following buckets, minutes 0-3, minutes 3-10, minutes 10-36, minutes 36-64, minutes 64-111, minutes 111-295, minutes 295-461, minutes 461-787, minutes 787-2,321, and minutes 2,321+. Though these time ranges are not immediately intuitive, they result in the highest predictive power when crossed with a categorical feature.

### Complexity Analysis

A problem of finding the optimal n-bucketing boundaries for a numerical feature X given a categorical feature X_{categorical}, such that the final crossed feature denoted as X_{categoricalXnumerical_n} has the largest information gain among all possible n-bucketing ways for the numerical feature is a NP-complete problem. The desired number of buckets for the numerical feature X is n. The dimension of the categorical feature is m. The time complexity for generating a crossed feature with n×m categories is O(n×m). The number of possible splits for numeric feature X is s. Therefore, for the kth recursive step, the time complexity is O(s×k×m). Because the recursive step is for n−1 times, after the summation, the time complexity of the heuristic algorithm is O(s×n²×m). If a brute-force approach is implemented to search for the optimal solution, then the possible bucketing candidates are all n combination in a set of size s, combination

$$( \frac{n}{s} ) .$$

Thus, the brute-force time complexity is

$$O ( \frac{s i}{s i ( s - n )} \times m ) .$$

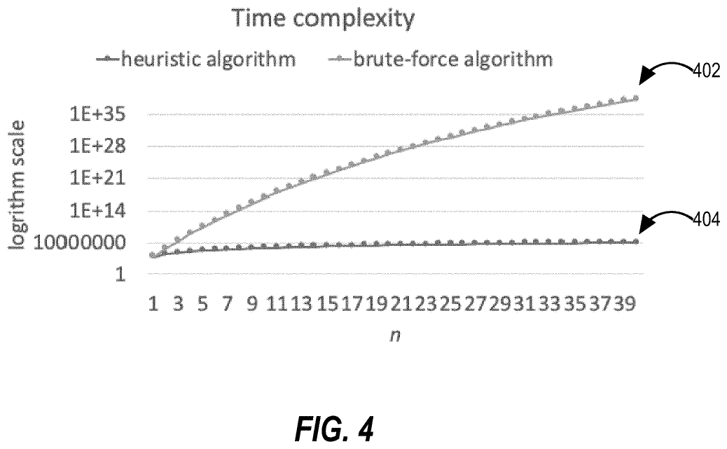

For example, FIG. 4 is a chart that illustrates a time complexity as the number of buckets n increases from 1 to 40, where s=150 and m=40. Line 402 illustrates how time complexity increases substantially as the number of buckets increases if a brute-force algorithm is implemented. Line 404 illustrates how time complexity increases much less substantially as the number of buckets increases if the heuristic algorithm of process 200 is implemented.

### Optimizing the Number of Buckets

As noted above, the count parameter (n) dictates a number of buckets or categories that will be associated with a numerical feature. Instead of being specified by a user (e.g., a software developer that designs the machine-learning model that incorporates the new cross feature), the number of buckets may be derived automatically.

In an embodiment, a threshold value (a) is defined such that when a difference between (1) the estimated predictive power of a candidate cross feature (e.g., X_{categoricalXnumerical_n+1}) that is based on n+1 buckets and (2) the estimated predictive power of a candidate cross feature (e.g., X_{categoricalXnumerical_n}) is less than the threshold value (a), the algorithm converges and the output is the candidate cross feature X_{categoricalXnumerical_n}. Example values for threshold value (a) are values less than 0.001.

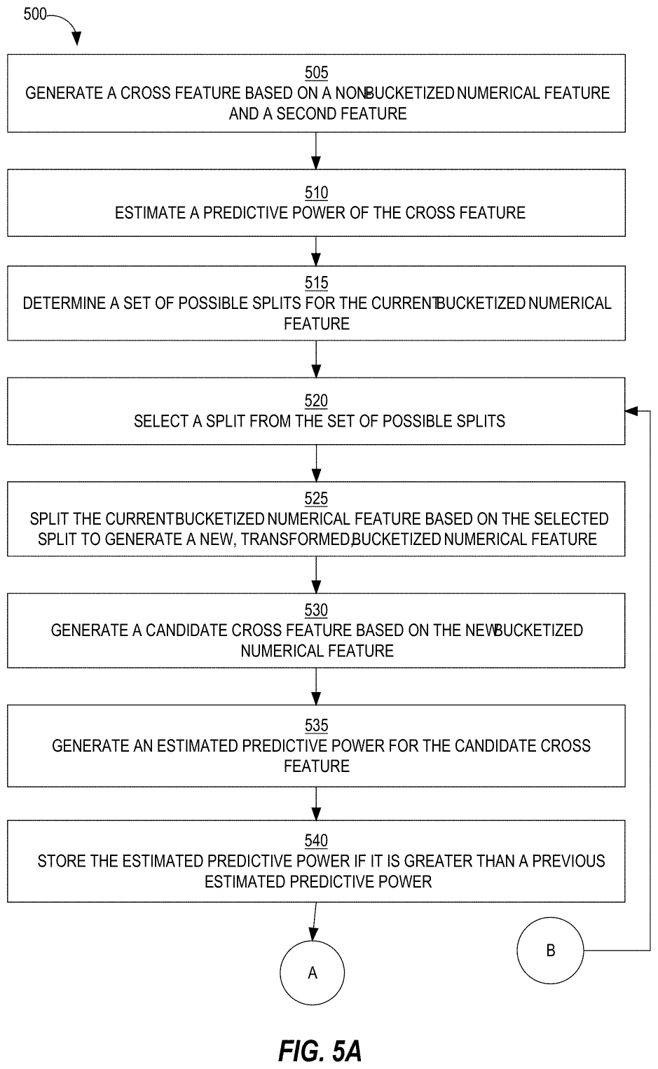

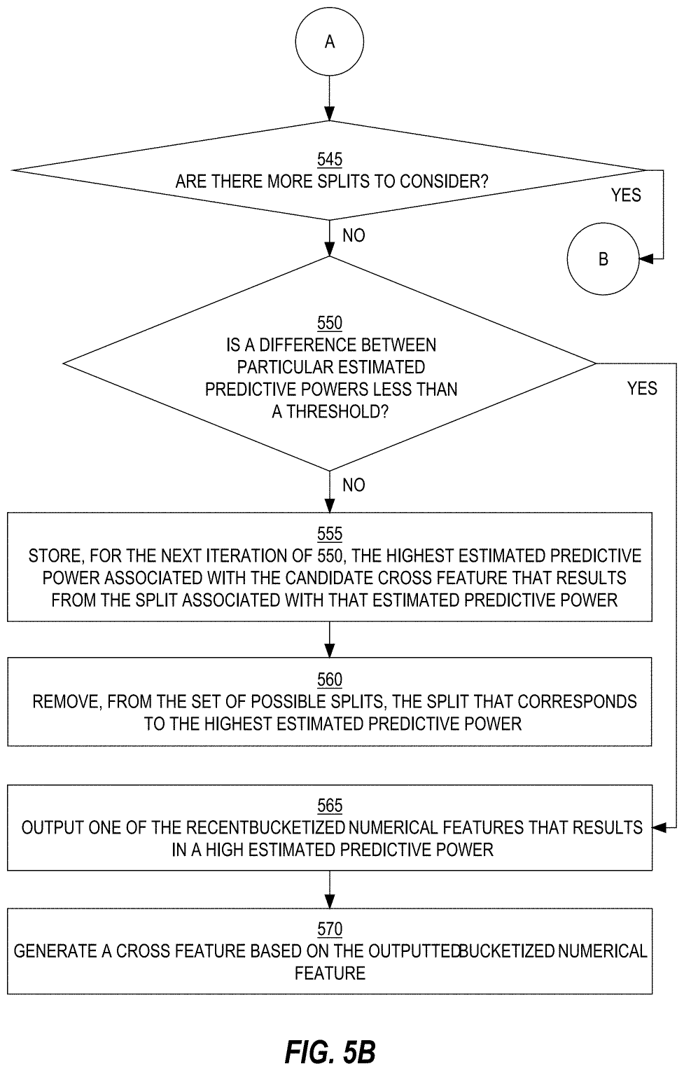

FIGS. 5A-5B are flow diagrams that depict an example process 500 for generating a cross categorical feature from a numerical feature, which process relies on a threshold change in estimated predictive power to determine when to terminate the process, in an embodiment. Process 500 is similar to process 200.

At block 505, a cross feature is generated that based on a single-bucket (or non-bucketized) numerical feature (X_{numerical_1}) and a second feature, such as a categorical feature (X_{categorical}).

At block 510, a predictive power is estimated for the cross feature generated in block 505. The predictive power is stored for later comparison. Blocks 505-510 are optional.

At block 515, a set of possible splits is determined for the current bucketized (or non-bucketized, if this is the first iteration of block 515) numerical feature (i.e., X_{numerical_k}). Initially, at the first iteration of block 515, the numerical feature is denoted X_{numerical_1} and comprises a single bucket. Thus, X_{numerical_1} has not been split yet. At the second iteration of block 515, the numerical feature is denoted X_{numerical_2} and comprises two buckets.

The set of possible splits is determined based on a minimum resolution of the numerical feature (e.g., one second, one minute, one day, one week, one month, or one year, depending on the domain of the numerical feature), a minimum value of the numerical feature, and a maximum value of the numerical feature. The number of splits in the set of possible splits is the ratio of (1) the difference of the maximum value and minimum value to (2) the minimum resolution.

At block 520, a split from the set of possible splits is selected. Block 520 is similar to block 210.

At block 525, the current bucketized numerical feature is split based on the selected split to generate a new, or transformed, bucketized numerical feature. Thus, at the first iteration of block 525, X_{numerical_1} becomes X_{numerical_2}. At the second iteration of block 525, X_{numerical_2} becomes X_{numerical_3}.

At block 530, a candidate cross feature is generated based on the new bucketized numerical feature. For example, at the first iteration of block 530, X_{numerical_2} is crossed with X_{categorical} to generate X_{categoricalXnumerical_2}. At the second iteration of block 530, X_{numerical_3} is crossed with X_{categorical} to generate X_{categoricalXnumerical_3}.

At block 535, a predictive power is estimated for the candidate cross feature generated in block 530. For example, an information gain is calculated for the candidate cross feature.

At block 540, the estimated predictive power is stored if it is greater than a previously estimated predictive power for currently-considered possible splits. At the first iteration of block 540, the estimated predictive power may involve determining whether it is greater than the estimated predictive power calculated in block 510. Alternatively, at the first iteration of block 540, the estimated predictive power may be stored regardless of whether block 510 is performed. At the second iteration of block 540, it is determined whether the estimated predictive power calculated in the second iteration of block 535 is greater than the estimated predictive power calculated in the first iteration of block 535. Thus, the estimated predictive power calculated in the most recent iteration of block 535 may overwrite a previous estimated predictive power if this estimated predictive power is greater than the previous estimated predictive power.

Alternative to this version of block 540, block 540 may instead involve storing the estimated predictive power in a set of estimated predictive powers (which set is initially empty), similar to block 230 in FIG. 2A. Later, in block 550, the set of estimated predictive powers would be analyzed to select the highest estimated predictive power, similar to block 250 in FIG. 2B. However, block 230 may be similar to block 540.

At block 545, it is determined whether there are more splits to consider in the set of possible splits of the current bucketized numerical feature. If so, then process 500 returns to block 520 to select another split that has not yet been considered for the current bucketized numerical feature. Otherwise, process 500 proceeds to block 550.

At block 550, it is determined whether a difference between (1) the estimated predictive power of the cross feature (X_{categoricalXnumeric_k+1}) that results from the split (of the current bucketized numerical feature) that provides the highest estimated predictive power AND (2) the estimated power of the cross feature (X_{categoricalXnumeric_k}) that results from the split (of the previous bucketized numerical feature) that provides the highest estimated predictive power is less than a threshold value (a). An example value of the threshold value is 0.001. In mathematical notation, this determination may be reflected in the following: IG(X_{categoricalXnumeric_k+1})−IG(X_{categoricalXnumeric_k})<α, wherein IG refers to information gain as the technique for estimating predictive power.

If the determination in block 550 is positive, then process 500 proceeds to block 565; otherwise, process 500 proceeds to block 555.

At block 555, the highest estimated predictive power associated with the cross feature (X_{categoricalXnumeric_k+1}) that results from the split associated with that estimated predictive power is stored for the next iteration of block 550.

At block 560, the split associated with the highest estimated predictive power determined in block 555 is removed from the set of possible splits. Process 500 returns to block 515.

At block 565, the bucketized numerical feature (X_{numerical_k}) is output or returned as a result of process 500. While X_{numerical_k+1} may have been output instead (since the estimated predictive power of X_{numerical_k+1} may have been greater than the estimated predictive power of X_{numerical_k}), generally, the fewer the number of buckets the faster the training time, which includes feature generation.

At block 570, a cross feature is generated based on that bucketized numerical feature. The cross feature may be denoted X_{categoricalXumerical_k}. Alternatively, since the cross feature was generated previously when testing different splits, that cross feature may be retrieved at this block (if old candidate cross features were retained in storage) instead of having to generate the cross feature again.

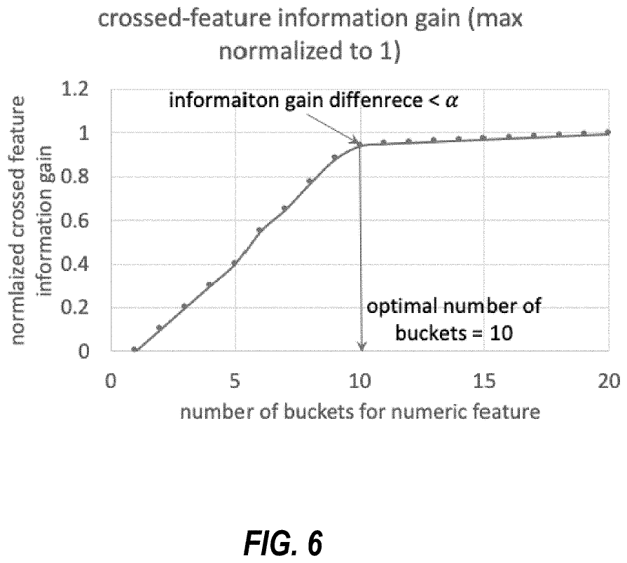

FIG. 6 is a chart that illustrates how estimated predictive power (or information gain in this example) converges and how the number of buckets (n) can be determined by a given threshold value (a). In this example, as the number of buckets increases incrementally from 0 to 10, the information gain from one bucket number to the next also increases substantially. However, after 10 buckets, the information gain does not increase appreciably. Thus, the algorithm may stop splitting buckets of the numerical feature and generate a cross feature based on the current number of buckets (n).

### Crossing Two Numerical Features

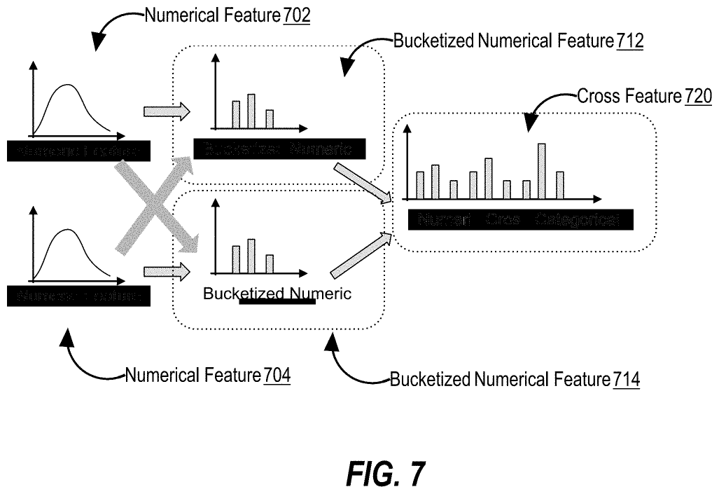

In an embodiment, two numerical features are bucketized and crossed with each other, where the bucketization of one numerical feature dictates the bucketization of the other numerical feature. FIG. 7 is a diagram that depicts an overview of a process for generating a cross feature based on two numerical features, in an embodiment. A cross feature 720 is ultimately based on two (“base”) features: numerical feature 702 and numerical feature 704. First, numerical feature 702 is bucketized to generate bucketized numerical feature 712 and numerical feature 704 is bucketized to generate bucketized numerical feature 714. Bucketized numerical features 712 and 714 are used as input to generate cross feature 720.

For example, there may be N1 possible splits for numerical feature X and N2 possible splits for numerical feature Y. A heuristic approach described herein searches through all the possible splits (N1+N2) for one optimal split per iteration. The result of following one of the heuristic approaches herein will be n1 splits for numerical feature X and n2 splits for numerical feature Y. It is possible that the final result has only one split for numerical feature X and all remaining splits for numerical feature Y, or the other way around, or the same number of splits for numerical features X and Y. In other words, arbitrary values of n1 and n2 when algorithm converges.

### Crossing More than Two Features at a Time

In an embodiment, a cross feature is generated on three or more base features, at least one of which is a numerical feature. As long as there are enough training samples, more than two features may be crossed at the same time using the approaches described herein. For each newly generated category in the cross feature, a certain number of training samples fall into that category, such as 0.1% of the total number of samples. A key point is searching for one split per iteration. Then, the remaining possible splits are searched in subsequent iterations.

### Model Performance Evaluation

In an embodiment, once a cross feature has been generated, the cross feature is incorporated into a machine-learned model. After the machine-learned model is trained, the model is evaluated to determine its performance. Example performance evaluation techniques include normalized entropy, AUC (or area under the curve), AUPR (area under the precision-recall curve), and OE (observed/expected) ratio. If a performance measure of the new model that is based on the newly-generated cross feature is better than a performance measure of another (e.g. base) model that is not based on that cross feature, then the new model replaces the other model in production to make decisions in processing “live” requests from end-users and optionally, regarding what to present.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

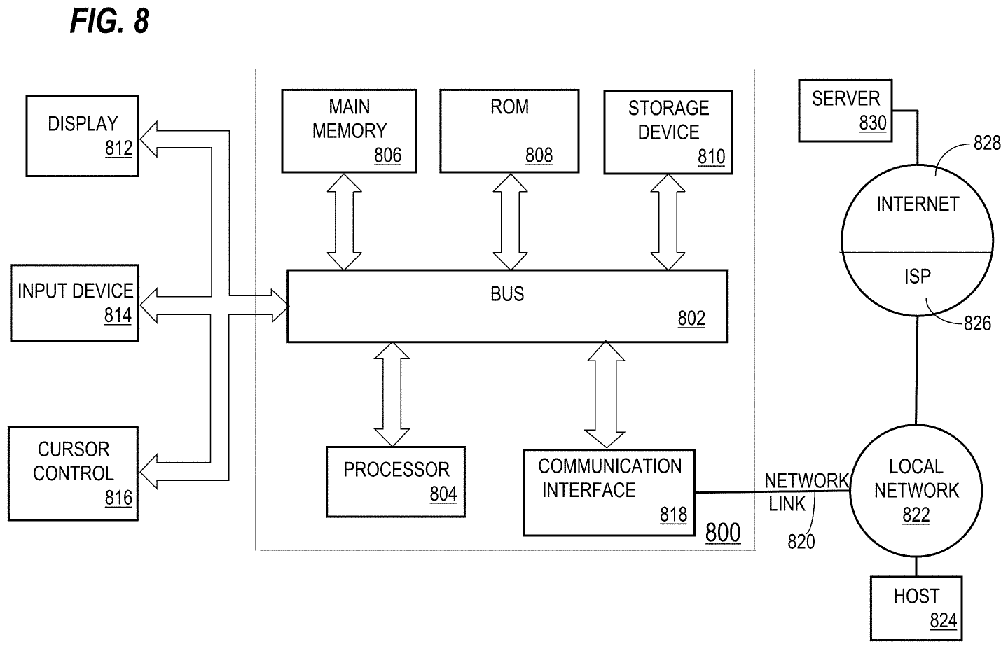

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying a first plurality of possible splits of a first feature that is a numeric feature;
for each split of the first plurality of possible splits:
transforming the first feature into a second feature based on said each split;
generating a cross feature based on the second feature and a third feature that is different than the first feature and the second feature;
estimating a predictive power of the cross feature;
adding the predictive power to a set of estimated predictive powers;
selecting a first cross feature that is associated with the highest estimated predictive power in the set of estimated predictive powers, wherein the first cross feature corresponds to a first split in the first plurality of possible splits;
splitting the first feature based on the first split to generate a fourth feature that is different than the first feature;
wherein the method is performed by one or more computing devices.

2. The method of claim 1, wherein the fourth feature comprises one more bucket than the first feature.

3. The method of claim 1, further comprising:
determining a minimum resolution of the first feature;
determining a minimum value of the first feature;
determining a maximum value of the first feature;
wherein identifying the first plurality of possible splits is based on the minimum resolution, the minimum value, and the maximum value.

4. The method of claim 1, wherein transforming the first feature into the second feature based on the said each split comprises:
identifying a particular bucket of the first feature that is to be split based on said each split;
generating a first bucket and a second bucket based on the particular bucket;
wherein a first boundary of the first bucket is the same as a first boundary of the particular bucket;
wherein a second boundary of the first bucket is based on said each split;
wherein a first boundary of the second bucket is based on said each split;
wherein a second boundary of the second bucket is the same as a second boundary of the particular bucket.

5. The method of claim 1, wherein estimating the predictive power of the cross feature comprises calculating an entropy of a label and an entropy of the label given the cross feature.

6. The method of claim 1, further comprising:
removing the first split from the first plurality of possible splits to create a second plurality of possible splits.

7. The method of claim 1, further comprising:
for each split of a second plurality of possible splits of the fourth feature:
transforming the fourth feature into a fifth feature based on said each split;
generating a second cross feature of the fifth feature and the third feature;
estimating a second predictive power of the second cross feature;
adding the second predictive power to a second set of estimated predictive powers;
selecting a third cross feature that is associated with the highest estimated predictive power in the second set of estimated predictive powers, wherein the third cross feature corresponds to a second split in the second plurality of possible splits;
splitting the fourth feature based on the second split to generate a sixth feature that is different than the first, third, and fourth features.

8. The method of claim 7, further comprising:
generating a first estimate of predictive power of the first cross feature;
generating a second estimate of predictive power of the third cross feature;
determining whether a difference between the first estimate and the second estimate is less than a threshold value;
using the first cross feature or the third cross feature as a feature when training a model in response to determining that the difference between the first estimate and the second estimate is less than the threshold value.

9. The method of claim 7, further comprising:
incrementing a count, wherein the count has a particular value prior to selecting the first cross feature;
after selecting the first cross feature, determining whether the count equals a threshold value;
in response to determining that the count does not equal the threshold value, transforming the fourth feature into the fifth feature;
incrementing the count;
after selecting the third cross feature, determining whether the count equals the threshold value;
in response to determining that the count equals the threshold value, using the third cross feature as a feature when training a model.

10. The method of claim 1, wherein the first feature is a time-based feature and the second feature is a categorical feature.

11. One or more storage media storing instructions which, when executed by one or more processors, cause:
identifying a first plurality of possible splits of a first feature that is a numeric feature;
for each split of the first plurality of possible splits:
transforming the first feature into a second feature based on said each split;
generating a cross feature based on the second feature and a third feature that is different than the first feature and the second feature;
estimating a predictive power of the cross feature;
adding the predictive power to a set of estimated predictive powers;
selecting a first cross feature that is associated with the highest estimated predictive power in the set of estimated predictive powers, wherein the first cross feature corresponds to a first split in the first plurality of possible splits;
splitting the first feature based on the first split to generate a fourth feature that is different than the first feature.

12. The one or more storage media of claim 11, wherein the fourth feature comprises one more bucket than the first feature.

13. The one or more storage media of claim 11, wherein the instructions, when executed by the one or more processors, further cause:
determining a minimum resolution of the first feature;
determining a minimum value of the first feature;
determining a maximum value of the first feature;
wherein identifying the first plurality of possible splits is based on the minimum resolution, the minimum value, and the maximum value.

14. The one or more storage media of claim 11, wherein transforming the first feature into the second feature based on the said each split comprises:
identifying a particular bucket of the first feature that is to be split based on said each split;
generating a first bucket and a second bucket based on the particular bucket;
wherein a first boundary of the first bucket is the same as a first boundary of the particular bucket;
wherein a second boundary of the first bucket is based on said each split;
wherein a first boundary of the second bucket is based on said each split;
wherein a second boundary of the second bucket is the same as a second boundary of the particular bucket.

15. The one or more storage media of claim 11, wherein estimating the predictive power of the cross feature comprises calculating an entropy of a label and an entropy of the label given the cross feature.

16. The one or more storage media of claim 11, wherein the instructions, when executed by the one or more processors, further cause:
removing the first split from the first plurality of possible splits to create a second plurality of possible splits.

17. The one or more storage media of claim 11, wherein the instructions, when executed by the one or more processors, further cause:
for each split of a second plurality of possible splits of the fourth feature:
transforming the fourth feature into a fifth feature based on said each split;
generating a second cross feature of the fifth feature and the third feature;
estimating a second predictive power of the second cross feature;
adding the second predictive power to a second set of estimated predictive powers;
selecting a third cross feature that is associated with the highest estimated predictive power in the second set of estimated predictive powers, wherein the third cross feature corresponds to a second split in the second plurality of possible splits;
splitting the fourth feature based on the second split to generate a sixth feature that is different than the first, third, and fourth features.

18. The one or more storage media of claim 17, wherein the instructions, when executed by the one or more processors, further cause:
generating a first estimate of predictive power of the first cross feature;
generating a second estimate of predictive power of the third cross feature;
determining whether a difference between the first estimate and the second estimate is less than a threshold value;
using the first cross feature or the third cross feature as a feature when training a model in response to determining that the difference between the first estimate and the second estimate is less than the threshold value.

19. The one or more storage media of claim 17, wherein the instructions, when executed by the one or more processors, further cause:
wherein a count has a particular value prior to selecting the first cross feature;
incrementing the count;
after selecting the first cross feature, determining whether the count equals a threshold value;
in response to determining that the count does not equal the threshold value, transforming the fourth feature into the fifth feature;
incrementing the count;
after selecting the third cross feature, determining whether the count equals the threshold value;
in response to determining that the count equals the threshold value, using the third cross feature as a feature when training a model.

20. The one or more storage media of claim 11, wherein the first feature is a time-based feature and the second feature is a categorical feature.
